(19) United States
(12) Patent Application Publication
(10) Pub. No.: US 2014/0337466 A1
(43) Pub. Date: Nov. 13, 2014

(54) PERSONA MANAGER FOR NETWORK COMMUNICATIONS

(71) Applicants: Hong Li, El Dorado Hills, CA (US); Eddie Balthasar, Folsom, CA (US); Rita H Wouhaybi, Portland, OR (US)

(72) Inventors: Hong Li, El Dorado Hills, CA (US); Eddie Balthasar, Folsom, CA (US); Rita H Wouhaybi, Portland, OR (US)

(73) Assignee: Intel Corporation, Santa Clara, CA (US)

(21) Appl. No.: 13/995,127

(22) PCT Filed: Dec. 28, 2011
(86) PCT No.: PCT/US2011/067605

§ 371 Date: Jun. 17, 2013

(51) Int. Cl. H04L 29/08

(52) U.S. Cl. CPC H04L 67/306; H04L 67/10
USPC 709/217

(57) ABSTRACT

A device for communicating via a network includes a processor, a memory containing persona instructions to cause the processor to obtain one of multiple persona profiles for use while communicating via the network, each persona profile controlling access to personal information of a user tailored to the type of communications being performed. A communication mechanism couples the network to perform communications between the device and the network using the obtained persona profile to share limited personal information.

### BACKGROUND

Preserving privacy while browsing the web is one of the top challenges faced by users. Privacy protection when browsing the web mainly relies on user awareness and manual actions to delete data collected or retained while browsing. Data to be deleted may include cache, cookies, history, etc. Some browsers may support settings to periodically delete data, or to delete such data upon receiving a user request. While not all users are privacy conscious, those that are must be disciplined and diligent in making sure private data is cleared or deleted, such as for example by providing a request to delete such data, or configuring a browser to periodically delete such data.

Many browsers support anonymous access to assist in keeping data private. However, using anonymous access may also be inconvenient for some frequently visited sites. Access to such sites may be greatly facilitated when data is retained between visits. Anonymous access results in such data being deleted so that it may not be used to facilitate such access.

### BRIEF DESCRIPTION OF THE DRAWINGS

FIG. 1 is a block architecture diagram of a web persona controller application according to an example embodiment.

FIG. 2 is a flowchart of a method of using the web persona controller application to control the provision of personal information to external entities according to an example embodiment.

FIG. 3 is a block diagram of a specifically programmed machine to implement methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

A persona manager allows selection of a privacy protection persona appropriate for the browsing activities of a user. The persona manager in one embodiment is a browser plugin utilizing hypertext markup language version 5 (HTML5). In some embodiments, the persona manager may be installed as an operating system service, with a browser plugin that would support many different browsers. For browsers and websites that support HTML5, the persona manager may provide personal security extensions available in HTML5.

Many different personas may be generated and used for browsing in a variety of situations, such as anonymous browsing, gaming, general web surfing, home use, and work use, to name a few. Each persona may have a different set of personalized information that may be available both to the user and to web site servers while the user is browsing the web. The personalized information may include web links, history, cookies, user account identifications, passwords, email addresses, personal data and other information. A persona for each different user browsing or communication activity may be selected by the user, or automatically selected based on context awareness. The persona manager also supports usages where it is not just about the privacy but also mode of operation or context of a user. For example, one might want a persona for home usage that would give them points or discounts for shopping at a certain site which should not carry over to their work persona. In such cases, the persona would allow the site to obtain and store information that sufficiently identifies the user to enable the tracking of points or discounts when using the same persona.

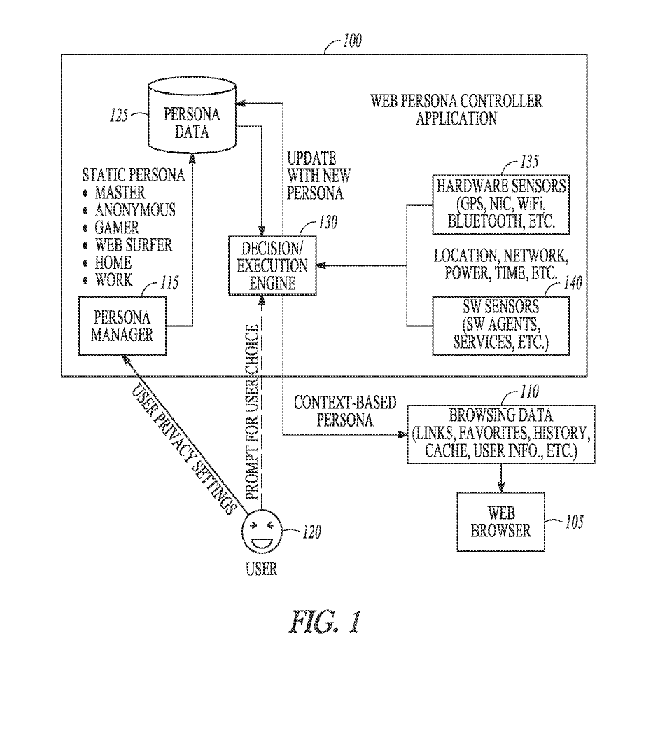

FIG. 1 is a block architecture diagram of a web persona controller application 100. In one embodiment, controller application 100 is a browser plugin that interfaces with a web browser 105, and controls the provision of personalized information represented at 110 to the browser 105 to be made available to external systems, servers, applications, and other entities communicating with the browser 105.

In one embodiment, web personal controller application 100 includes a persona manager 115 that manages the use, creation, and selection of personas for a user 120. The user may desire many different personas depending on the communication activities of the user 120. Typical personas include a master persona that contains all personalized information for the user, an anonymous persona that contains little to no personalized information. Other personas may include a gamer persona, web surfer personal, home persona, and work persona. Each persona may contain differing amounts of personalized information appropriate for the activity and the user's desires for privacy. The personas and associated personal information is contained in a persona database 125, a secure repository for persona information.

Typical data available for the different personas contains web links, history, cookies, user account identifications, passwords, email addresses, personal data and other information. All the information is stored in the master persona, while subsets may be stored with other personas. The personas may be used to remove or save cookies following browsing sessions depending on privacy settings of the persona used.

A decision/execution engine 130 may prompt the user for choice of persona to use while a user is performing different communication activities. The engine 130 updates the persona database 125, and also obtains the information from the persona database 125 to share for the activity, and provides access to the information indicated at 110 to the browser 105. In some embodiments, the engine 130 provides further information from hardware sensors, such as (GPS), (NIC), (WiFi), Bluetooth, etc indicated at 135 to provide location, network, power, time, and other information. Further information that may be provided is obtained from software sensors at 140. Software sensors may include for example, software agents, services and other software. They provide data to the engine 130 which is filtered based on the selected persona and provided via 110 to the browser to be available for providing to external entities such as websites.

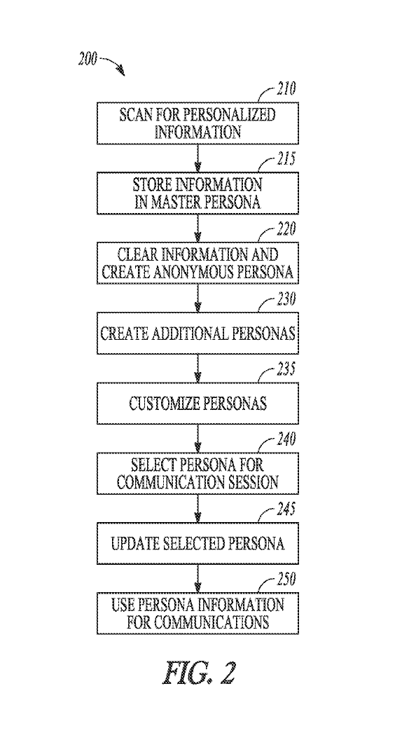

FIG. 2 illustrates a method 200 of using the web persona controller application to control the provision of personal information to external entities. When a user first launches the web persona controller application 100, the application scans a device it is running on at 210 for personalized information that will be used in communicating with external entities including servers of web pages and external programs. The information includes for example, web links, history, cookies, ID's, passwords, email addresses, personal data and other data. The information may be stored in a secure repository, such as persona database 125 as a master persona at 215. Alternatively, the application may be implemented as a browser plug-in that functions in the same manner after the browser is launched for the first time.

The web personal controller application then clears the personal data accessible via the browser and web applets, and creates another profile at 220 called an anonymous persona profile for casual browsing. The user now has two personas, master and anonymous, and is ready to browse the web. In some embodiments, the application provides a list of other common personas that a user may desire, such as gamer, home, or work for example. The user may select those personas which may have predetermined subsets of personal data associated with them, or create one or more custom personas of the user's choice, and have such personas stored for use at 230.

The user may customize the personal data for each persona as desired at 235, and select the appropriate persona for each communication session such as a browsing session at 240. Work and home personas for example, may be associated with different locations. A user may have multiple personas associated with different locations, such as a vacation home, or remote office that is frequently or occasionally visited.

The user is free to control the granularity of different personas as desired. One example may be a sports persona, while a user desiring more granularity may divide sports into several different individual sports, such as golf, basketball, or hockey. Even further granularity would be evident in selecting different persona for different teams or players.

In one example, the user may be interested in a new mortgage, or in refinancing an existing mortgage. The user may then create or use an existing persona, specifying the information the user would like available during this session. As the user visits different websites, the persona may be updated with additional information at 245, and may be used to identify the user, such as by providing an email address and other information at 250. As part of updating the persona at 245, the persona may keep track of sign-in information including passwords at different sites used, and may also keep a history of sites visited. The persona may also specify that selected information is not to be retained when desired for the associated activity. When revisiting a site, the persona may provide the sign-in information to the user at 250 such as by a pop-up window instrumented by the persona controller application or add-on, to allow the user to sign in using the same information as previously, and in some embodiments, the persona may be used by the persona controller application or add-on to auto-populate the sign in information at 250. The email address may be a contrived or fake email address, or a separate valid email address used just for searching for the mortgage. False information may also be referred to as personal information. Since some websites may continually send information about mortgages for well beyond the potential period of interest of the user, the user's main home/personal email and work email addresses will not receive these emails, and the user may just discard the “mortgage persona” email address when interest in the subject is over. Similar personas may be generated for different interests that may be long or short term interests.

When the user starts a browser or other program that interacts with other entities over a network, the web persona controller application may facilitate the user, either by static policy settings before starting a browser, or dynamic, context aware settings, to create additional personas that may contain some, all, or even fake information. This allows the user to create and save new and different personas that could include different links, cookies, email addresses, etc., based on context based user privacy desires. Many aspects of the creation and use of such personas may be automated by the persona controller application in various embodiments.

In some embodiments, one or more application program interfaces (APIs) to HTML5 websites and application allow a query for access as a persona or even specify in which set of personas user data should be saved. Such APIs may be used to automate persona management, freeing the user from some burdens of managing different persona. Once additional personas have been created, the user may save an existing persona, or use any other persona, including the anonymous persona.

During web browsing, the web persona controller application may continuously scan for requests of personal data, make decisions for the user on which persona to use based on the user settings or context-aware algorithms at 250, prompt the user with relevant context and choices so that the user may pick the right persona for a specific web site, or even allow the HTML5 website to specify where to include the data. The relevant context may include device information about memory, physical sensors, battery life, and the like, as well as other context information such as user location (geo, work, home) time, type/strength of network connection, purpose/reputation of the web link, etc. This information might be used locally by the algorithm and will not be communicated back to any server, following the HTML5 privacy guidelines. This information may utilize an additional component such as additional data sources as well as software and hardware sensor that provide the context information. Algorithms may be used to fuse data from the sensors and make sense in a context perspective, selecting the appropriate persona at 240 to use depending on the context.

One example of context perspective includes the use of a travel type of persona that exposes location information based on GPS or other position indicating mechanisms. Using this persona, shopping for tickets for an event may expose the user's position current position, which may be used if shopping for tickets for a concert on the same day. However, if the user is shopping for tickets on a weekend, the context of use may indicate that the user normally is home on weekends, and the venue of the concert is likely to be where the user is normally located on weekends. The position information or other information derived from sensors may also be referred to as personal information. This information can also be extracted using a fusion of several hardware and software sensors, such as calendar information, if the user's privacy settings allow for such a fusion.

In further embodiments, personas may be stored on secure remote storage devices, sometimes referred to as the cloud. Then, a user may use many different devices, and utilize the various personas stored in the cloud. The sensed location of the device may be used to select the proper persona based on the type of device and the location of the device, or based on user selection.

A further example persona includes a shopping persona, which may have sign-in information and credit card information accessible for use in shopping on various websites. The shopping persona controls which information is retained and which information may be shared in one embodiment.

In some embodiments, checkpoints may be set for each persona prior to each internet session. At any point, a user's persona may be reset to an older version, preventing new cookies or other personal tracking data to be easily removed from the user's environment. This feature may be useful when a website generates many cookies in a cookie explosion. It allows the persona to be rolled back to delete the cookies. HTML5 security and privacy is still being defined in the respective working groups. With ongoing adoption of HTML5 as a future choice of many experiences and application, managing personas to protect personal data and preferences becomes even more pressing. Persona management may also be part of a native app even though it may not be as pervasive.

HTML5 websites and applications may have access to more detailed information about the device and the behavior of the user since many of the currently hidden interfaces will be exposed. As of the date of filing this application, HTML5 is still under development and is the fifth version of the language that improves support for the latest multimedia while maintaining easy readability by humans. Many features of HTML5 are compatible with mobile devices. Application programming interfaces have been integrated into HTML5.

The checkpoints may use HTML5 capabilities and resides in the browser, providing the user with a mechanism to control the user's data and privacy settings. However, manual management of such settings may be challenging for the average user. In one embodiment, some exposed APIs allow HTML5 applications to facilitate some of the privacy management. For example, when a user visits a bank where the user performs banking activities, some of the settings of account layout may be used on the device in order to maintain a consistent experience from one session to another. The banking HTML5 app will prompt the user for a level of trust. If the user confirms a high level, then the application will have enough access rights to specify that these settings should belong to a set of personas, but be disabled in anonymous mode or during untrusted sessions.

The web persona controller application provides protection of user privacy while browsing the web, allowing users and devices to create differentiated personas for different web applications and services. The application may be implemented with existing technologies and standards such as HTML5 and XML schema. The personas may be updated dynamically based on the user and device context, providing better user privacy and improving the user browsing experience.

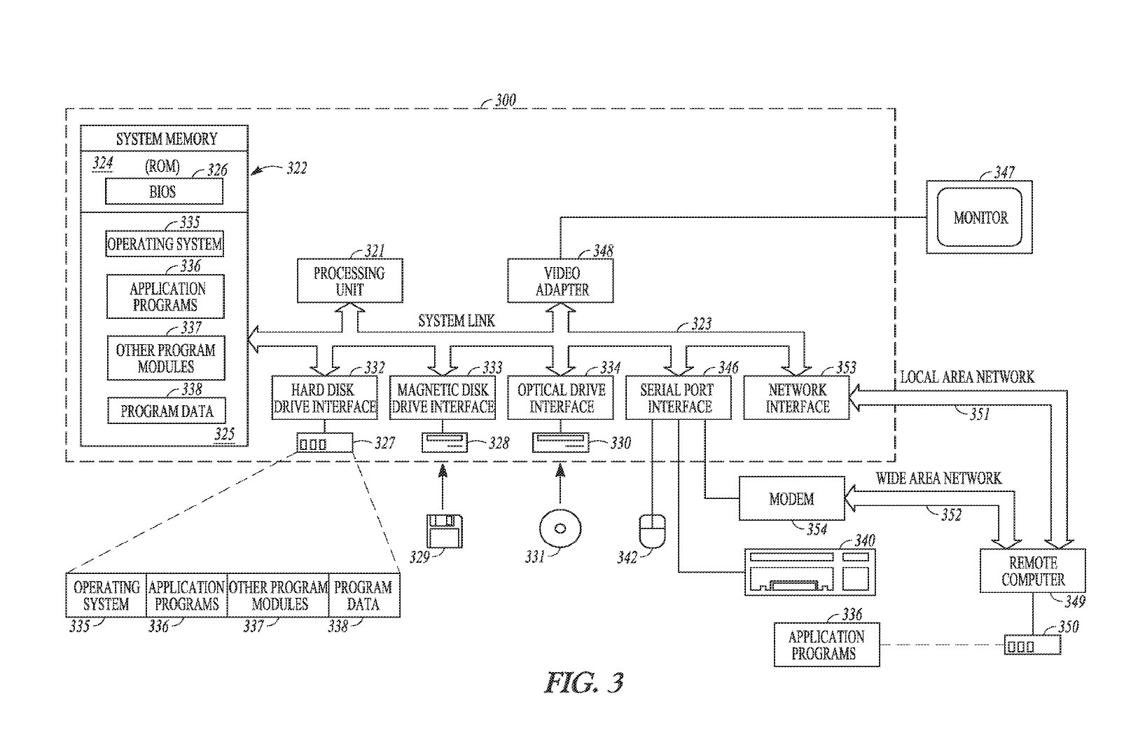

FIG. 3 is a block diagram of a specifically programmed computer system to implement methods according to an example embodiment. In the embodiment shown in FIG. 3, a hardware and operating environment is provided to enable the computer system to execute one or more methods and functions that are described herein.

As shown in FIG. 3, one embodiment of the hardware and operating environment includes a general purpose computing device in the form of a computer 300 (e.g., a personal computer, workstation, or server), including one or more processing units 321, a system memory 322, and a system link 323, such as for example a bus or interconnect that operatively couples various system components including the system memory 322 to the processing unit 321. There may be only one or there may be more than one processing unit 321, such that the processor of computer 300 comprises a single processing unit, or a plurality of processing units, commonly referred to as a multiprocessor or parallel-processor environment. In various embodiments, computer 300 is a conventional computer, a distributed computer, or any other type of computer.

The link 323 may be any of several types of bus or interconnect structures including a memory bus or interconnect or memory controller, a peripheral bus or interconnect, and a local bus or interconnect using any of a variety of bus architectures. The system memory may also be referred to as simply the memory, and, in some embodiments, includes read-only memory (ROM) 324 and random-access memory (RAM) 325. A basic input/output system (BIOS) program 326, containing the basic routines that help to transfer information between elements within the computer 300, such as during start-up, may be stored in ROM 324. The computer 300 further includes a hard disk drive 327 for reading from and writing to a hard disk, not shown, a magnetic disk drive 328 for reading from or writing to a removable magnetic disk 329, and an optical disk drive 330 for reading from or writing to a removable optical disk 331 such as a CD ROM or other optical media.

The hard disk drive 327, magnetic disk drive 328, and optical disk drive 330 couple with a hard disk drive interface 332, a magnetic disk drive interface 333, and an optical disk drive interface 334, respectively. The drives and their associated computer-readable media provide non volatile storage of computer-readable instructions, data structures, program modules and other data for the computer 300. It should be appreciated by those skilled in the art that any type of computer-readable media which may store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, may be used in the exemplary operating environment.

A plurality of program modules may be stored on the hard disk, magnetic disk 329, optical disk 331, ROM 324, or RAM 325, including an operating system 335, one or more application programs 336, other program modules 337, and program data 338. Programming for implementing one or more processes or method described herein may be resident on any one or number of these computer-readable media.

A user may enter commands and information into computer 300 through input devices such as a keyboard 340 and pointing device 342. Other input devices (not shown) may include a microphone, joystick, game pad, satellite dish, scanner, or the like. These other input devices are often connected to the processing unit 321 through a serial port interface 346 that is coupled to the link 323, but may be connected by other interfaces, such as a parallel port, game port, or a universal serial bus (USB). A monitor 347 or other type of display device may also be connected to the link 323 via an interface, such as a video adapter 348. The monitor 347 may display a graphical user interface for the user. In addition to the monitor 347, computers typically include other peripheral output devices (not shown), such as speakers and printers.

The computer 300 may operate in a networked environment using logical connections to one or more remote computers or servers, such as remote computer 349. These logical connections are achieved by a communication device coupled to or a part of the computer 300; the invention is not limited to a particular type of communications device. The remote computer 349 may be another computer, a server, a router, a network PC, a client, a peer device or other common network node, and typically includes many or all of the elements described above I/O relative to the computer 300, although only a memory storage device 350 has been illustrated. The logical connections depicted in FIG. 3 include a local area network (LAN) 351 and/or a wide area network (WAN) 352. Such networking environments are commonplace in office networks, enterprise-wide computer networks, intranets and the internet, which are all types of networks.

When used in a LAN-networking environment, the computer 300 is connected to the LAN 351 through a network interface or adapter 353, which is one type of communications device. In some embodiments, when used in a WAN-networking environment, the computer 300 typically includes a modem 354 (another type of communications device) or any other type of communications device, e.g., a wireless transceiver, for establishing communications over the wide-area network 352, such as the internet. The modem 354, which may be internal or external, is connected to the link 323 via the serial port interface 346. In a networked environment, program modules depicted relative to the computer 300 may be stored in the remote memory storage device 350 of remote computer, or server 349. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

### EXAMPLES

### Example 1

A device for communicating via a network, the device comprising: a processor; a memory containing persona instructions to cause the processor to obtain one of multiple persona profiles for use while communicating via the network, each persona profile controlling access to personal information of a user, the controlling access tailored to the type of communications being performed; and

a communication mechanism to couple to the network to perform communications between the device and the network.

### Example 2

The example device of example 1 wherein the communication mechanism is a browser stored on a computer readable storage device, and wherein the persona instructions comprise a browser plug-in.

### Example 3

The example device of example 1 or 2 wherein the persona profiles are stored on a secure database.

### Example 4

The example device of example 3 wherein the secure database is located on a remote storage device.

### Example 5

The example device of example 1, 2, 3, or 4 wherein the persona instructions include instructions to facilitate user management of the persona profiles.

### Example 6

The example device of example 1, 2, 3, 4, or 5 and further comprising hardware and software sensors to provide information to the processor.

### Example 7

The example device of example 6 wherein the hardware sensors provide location information for use in selecting a persona based on the location of the processor.

### Example 8

The example device of example 1, 2, 3, 4, 5, 6, or 7 wherein the selected persona is updated with information associated with multiple sites visited when the selected persona is used to visit multiple sites such that the information is available for a future session using the same selected persona, and wherein the selected persona auto-populates sign-in information for a website previously visited.

### Example 9

The example device of example 1, 2, 3, 4, 5, 6, 7, or 8 wherein the personal data is selected from the group consisting of web links, history, cookies, ID's, passwords, and email addresses.

### Example 10

A method for communicating via a network, the method comprising: selecting one of multiple persona based on communications to be performed, wherein each persona has an associated subset of user personal information stored on a machine readable device to be exposed while communicating; visiting a site via the network; updating the subset of user personal information associated with the selected persona; and providing user personal information to the site from the subset of user personal information associated with the persona.

### Example 11

The example method of example 10 wherein the user information associated with the persona is scrubbed following communications with the site.

### Example 12

The example method of example 10 or 11 wherein the multiple personas include a master persona and an anonymous persona.

### Example 13

The example method of example 12 wherein the master persona has all user personal information associated.

### Example 14

The example method of example 12 or 13 wherein the anonymous persona associated user personal information is deleted following communications with the site.

### Example 15

The example method of example 10, 11, 12, 13, or 14 wherein the selected persona is updated with information associated with multiple sites visited when the selected persona is used to visit multiple sites such that the information is available for a future session using the same selected persona.

### Example 16

The example method of example 15 wherein the selected persona auto-populates sign-in information for a website previously visited.

### Example 17

The example method of example 10, 11, 12, 13, 14, 15, or 16 wherein at least one persona contains contrived user personal information.

### Example 18

The example method of example 10, 11, 12, 13, 14, 15, 16, or 17 wherein at least one persona is a shopping persona containing user personal credit information to facilitate shopping at websites when the shopping persona is the selected persona.

### Example 19

The example method of example 10, 11, 12, 13, 14, 15, 16, 17, or 18 wherein the personal data is selected from the group consisting of web links, history, cookies, ID's, passwords, and email addresses.

### Example 20

The example method of example 10, 11, 12, 13, 14, 15, 16, 17, 18, or 19 wherein persona is selected as a function of context of the communications to be performed.

### Example 21

The example method of example 10, 11, 12, 13, 14, 15, 16, 17, 18, 19, or 20 wherein the context includes location.

### Example 22

A machine readable storage device having instructions stored thereon to cause a machine to perform any one of the methods of examples 10-21.

### Example 23

The example machine readable storage device of example 22 and further comprising a processor and display.

### Example 24

A machine readable storage device having instructions stored thereon for causing a machine to perform a method of generating persona profiles, the method comprising: scanning a device for personal user information; creating a master persona profile containing the personal user information; creating a further persona profile containing a subset of the personal user information; and selecting one of the multiple personas based on communications to be performed, wherein each persona has an associated subset of user personal information stored on a machine readable device to be exposed while communicating.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A device for communicating via a network, the device comprising:
a processor;
a memory containing persona instructions to cause the processor to obtain one of multiple persona profiles for use while communicating via the network, each persona profile controlling access to personal information of a user, the controlling access tailored to the type of communications being performed; and
a communication mechanism to couple to the network to perform communications between the device and the network.

2. The device of claim 1 wherein the communication mechanism is a browser stored on a computer readable storage device, and wherein the persona instructions comprise a browser plug-in.

3. The device of claim 1 wherein the persona profiles are stored on a secure database.

4. The device of claim 3 wherein the secure database is located on a remote storage device.

5. The device of claim 1 wherein the persona instructions include instructions to facilitate user management of the persona profiles.

6. The device of claim 1 and further comprising hardware and software sensors to provide information to the processor.

7. The device of claim 6 wherein the hardware sensors provide location information for use in selecting a persona based on the location of the processor.

8. The device of claim 1 wherein the selected persona is updated with information associated with multiple sites visited when the selected persona is used to visit multiple sites such that the information is available for a future session using the same selected persona, and wherein the selected persona auto-populates sign-in information for a website previously visited.

9. The device of claim 1 wherein the personal data is selected from the group consisting of web links, history, cookies, ID's, passwords, and email addresses.

10. A method for communicating via a network, the method comprising:
selecting one of multiple persona based on communications to be performed, wherein each persona has an associated subset of user personal information stored on a machine readable device to be exposed while communicating;
visiting a site via the network;
updating the subset of user personal information associated with the selected persona; and
providing user personal information to the site from the subset of user personal information associated with the persona.

11. The method of claim 10 wherein the user information associated with the persona is scrubbed following communications with the site.

12. The method of claim 10 wherein the multiple personas include a master persona and an anonymous persona.

13. The method of claim 12 wherein the master persona has all user personal information associated.

14. The method of claim 13 wherein the anonymous persona associated user personal information is deleted following communications with the site.

15. The method of claim 14 wherein the selected persona is tailored with information associated with multiple sites visited when the selected persona is used to visit multiple sites such that the information is available for a future session using the same selected persona.

16. The method of claim 15 wherein the selected persona auto-populates sign-in information for a website previously visited.

17. The method of claim 10 wherein at least one persona contains contrived user personal information.

18. The method of claim 10 wherein at least one persona is a shopping persona containing user personal credit information to facilitate shopping at websites when the shopping persona is the selected persona.

19. The method of claim 10 wherein the personal data is selected from the group consisting of web links, history, cookies, ID's, passwords, and email addresses.

20. The method of claim 10 wherein persona is selected as a function of context of the communications to be performed.

21. The method of claim 10 wherein the context includes location.

22. A machine readable storage device having instructions stored thereon to cause a machine to perform the methods of claim 10.

23. The machine readable storage device of claim 22 and further comprising a processor and display.

24. A machine readable storage device having instructions stored thereon for causing a machine to perform a method of generating persona profiles, the method comprising:
scanning a device for personal user information;
creating a master persona profile containing the personal user information;
creating a further persona profile containing a subset of the personal user information; and
selecting one of the multiple personas based on communications to be performed, wherein each persona has an associated subset of user personal information stored on a machine readable device to be exposed while communicating.
